(19) United States
(12) Patent Application Publication
(10) Pub. No.: US 2024/0424956 A1
(43) Pub. Date: Dec. 26, 2024

(54) WORK MACHINE CONTROL DEVICE AND WORK MACHINE CONTROL METHOD

(71) Applicant: Komatsu Ltd., Tokyo (JP)

(72) Inventor: Shota Yamawaki, Tokyo (JP)

(73) Assignee: Komatsu Ltd., Tokyo (JP)

(21) Appl. No.: 18/685,247

(22) PCT Filed: Sep. 29, 2022
(86) PCT No.: PCT/JP2022/036477

§ 371 Date: Feb. 21, 2024

(30) Foreign Application Priority Data
Sep. 30, 2021 (JP) 2021-161335

(51) Int. Cl. B60L 58/40

(52) U.S. Cl. CPC B60L 58/40; B60L 2200/40

(57) ABSTRACT

A load ratio determination unit determines a load ratio of each of a plurality of fuel cells based on desired electric power of a work machine. An operation instruction unit operates each of the plurality of fuel cells at the determined load ratio.

### TECHNICAL FIELD

The present disclosure relates to a control device of a work machine and a control method of a work machine.

Priority is claimed on Japanese Patent Application No. 2021-161335, filed Sep. 30, 2021, the content of which is incorporated herein by reference.

### BACKGROUND ART

In recent years, mounting a fuel cell on a work machine has been examined in order to power the work machine with clean energy instead of fossil fuels. In order to operate a large machine, such as a work machine, by a fuel cell, it is possible to mount a plurality of fuel cells (fuel cell modules) in parallel (for example, see Patent Document 1).

### CITATION LIST

### Patent Document

### Patent Document 1

PCT International Publication No. WO2021/064010

### SUMMARY OF INVENTION

### Technical Problem

On the other hand, it is known that efficiency of the fuel cells changes depending on a load ratio. For this reason, when causing the fuel cells mounted in parallel to evenly output the electric power needed for operating the work machine, it is not always possible to efficiently operate the fuel cells.

An object of the present disclosure is to provide a control device of a work machine and a control method of a work machine that can efficiently operate a plurality of fuel cells mounted on the work machine.

### Solution to Problem

According to an aspect of the present invention, a control device of a work machine is provided including a plurality of fuel cells, the control device including a load ratio determination unit configured to determine a load ratio of each of the plurality of fuel cells based on the needed electric power of the work machine and an operation instruction unit configured to operate each of the plurality of fuel cells at the determined load ratio.

### Advantageous Effects of Invention

According to the aspect, the plurality of fuel cells mounted on the work machine can be efficiently operated.

### BRIEF DESCRIPTION OF DRAWINGS

FIG. 1 is a side view schematically showing a transport vehicle according to a first embodiment.

FIG. 2 is a schematic block diagram showing configurations of a power system and a drive system of the transport vehicle according to the first embodiment.

FIG. 3 is a schematic block diagram showing a configuration of a control device according to the first embodiment.

FIG. 4 is a graph showing an example of a relationship between a load ratio and efficiency of a fuel cell.

FIG. 5 is a flowchart showing an operation of the control device according to the first embodiment.

FIG. 6 is a schematic block diagram showing a configuration of a control device according to a second embodiment.

FIG. 7 is a flowchart showing an operation of the control device according to the second embodiment.

FIG. 8 is a schematic block diagram showing a configuration of a computer according to at least one embodiment.

### Description of Embodiments

### First Embodiment

### Configuration of Transport Vehicle

Hereinafter, embodiments will be described in detail with reference to the drawings.

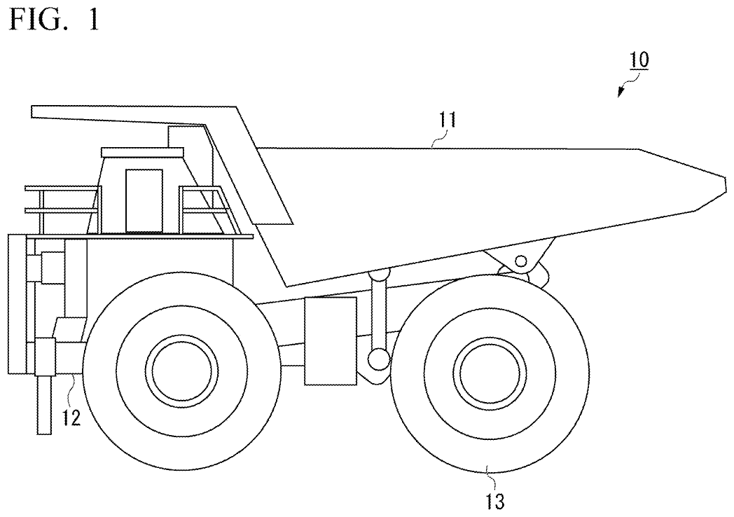

FIG. 1 is a perspective view schematically showing a transport vehicle 10 according to a first embodiment. The transport vehicle 10 is a dump truck that travels at a work site such as a mine to transport a load. The transport vehicle 10 may be an unmanned dump truck that operates in an unmanned manner regardless of a driving operation by a driver or may be a manned dump truck that operates based on the driving operation by the driver.

The transport vehicle 10 includes a dump body 11, a vehicle body 12, and a traveling device 13.

The dump body 11 is a member on which a load is placed. At least a part of the dump body 11 is disposed above the vehicle body 12. The dump body 11 performs a dumping operation and a lowering operation. Through the dumping operation and the lowering operation, the dump body 11 is adjusted to be in a dumping posture and a placement posture. The dumping posture refers to a posture in which the dump body 11 is raised. The placement posture refers to a posture in which the dump body 11 is lowered.

The dumping operation refers to an operation of separating the dump body 11 from the vehicle body 12 and inclining the dump body in a dumping direction. The dumping direction is the rear of the vehicle body 12. In the embodiment, the dumping operation includes raising a front end portion of the dump body 11 and inclining the dump body 11 rearward. Through the dumping operation, a placement surface of the dump body 11 is inclined downward toward the rear.

The lowering operation refers to an operation of bringing the dump body 11 closer to the vehicle body 12. In the embodiment, the lowering operation includes lowering of the front end portion of the dump body 11.

In a case of carrying out dumping work, the dump body 11 performs the dumping operation to change from the placement posture to the dumping posture. In a case where a load is placed on the dump body 11, the load is discharged rearward from a rear end portion of the dump body 11 through the dumping operation. When carrying out loading work, the dump body 11 is adjusted to be in the placement posture.

The vehicle body 12 includes a vehicle body frame. The vehicle body 12 supports the dump body 11. The vehicle body 12 is supported by the traveling device 13.

The traveling device 13 supports the vehicle body 12. The traveling device 13 causes the transport vehicle 10 to travel. The traveling device 13 causes the transport vehicle 10 to advance or retreat. At least a part of the traveling device 13 is disposed below the vehicle body 12. The traveling device 13 includes a pair of front wheels and a pair of rear wheels. The front wheels are steering wheels, and the rear wheels are driving wheels.

A power system 14 generates power for driving the traveling device 13 by causing a reaction between hydrogen and oxygen. Driving the traveling device 13 includes rotating of the rear wheels of the traveling device 13.

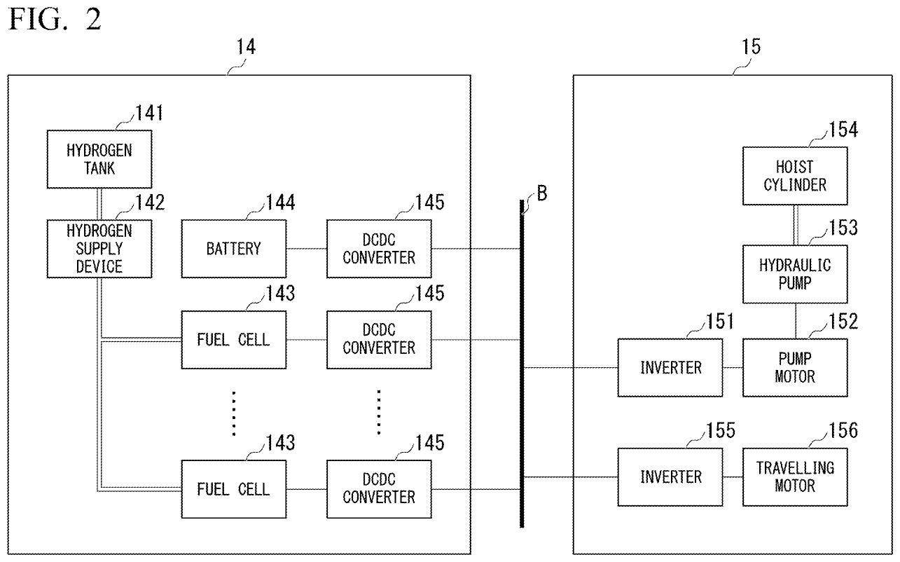

FIG. 2 is a schematic block diagram showing configurations of the power system 14 and a drive system 15 of the transport vehicle 10 according to the first embodiment. The power system 14 includes a hydrogen tank 141, a hydrogen supply device 142, a fuel cell 143, a battery 144, and a DCDC converter 145. The power system 14 includes a plurality of fuel cells 143. In the first embodiment, the number of fuel cells 143 is M. M is a natural number.

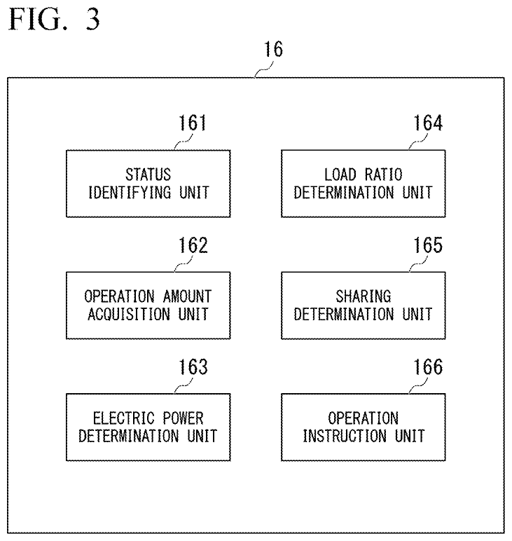

The hydrogen supply device 142 supplies hydrogen of the hydrogen tank 141 to the fuel cells 143. The fuel cells 143 generate electric power by causing an electrochemical reaction between hydrogen supplied from the hydrogen supply device 142 and oxygen included in outside air. The battery 144 stores the electric power generated by the fuel cells 143. The DCDC converter 145 causes that the electric power is output from the fuel cells 143 or the battery 144 connected in accordance with an instruction from a control device 16 (see FIG. 3). The power system 14 includes M+1 DCDC converters 145.

Electric power from the power system 14 is output to the drive system 15 via a bus B. The drive system 15 has an inverter 151, a pump drive motor 152, a hydraulic pump 153, a hoist cylinder 154, an inverter 155, and a travelling drive motor 156. The inverter 151 converts a direct current from the bus B into a three-phase alternating current and supplies the three-phase alternating current to the pump drive motor 152. The pump drive motor 152 drives the hydraulic pump 153. A hydraulic oil discharged from the hydraulic pump 153 is supplied to the hoist cylinder 154 via a control valve (not shown). As the hydraulic oil is supplied to the hoist cylinder 154, the hoist cylinder 154 operates. The hoist cylinder 154 causes the dump body 11 to perform the dumping operation or the lowering operation. The inverter 155 converts a direct current from the bus B into a three-phase alternating current and supplies the three-phase alternating current to the travelling drive motor 156. A rotational force generated by the travelling drive motor 156 is transmitted to the rear wheels of the traveling device 13.

### Configuration of Control Device 16

FIG. 3 is a schematic block diagram showing a configuration of the control device 16 according to the first embodiment. The control device 16 includes a status identifying unit 161, an operation amount acquisition unit 162, an electric power determination unit 163, a load ratio determination unit 164, a sharing determination unit 165, and an operation instruction unit 166.

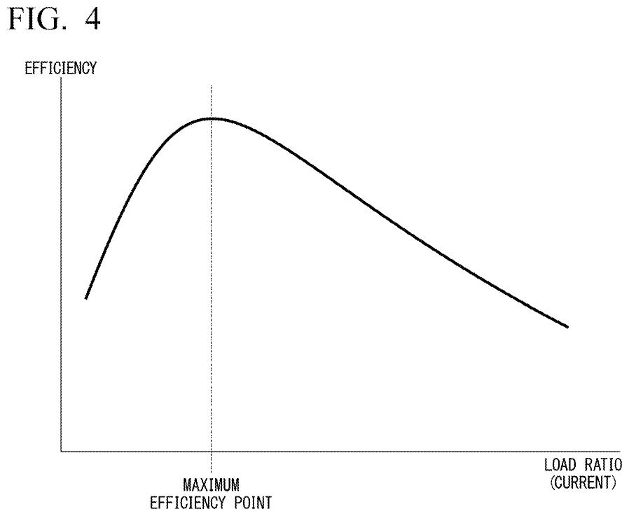

FIG. 4 is a graph showing an example of a relationship between a load ratio and efficiency of the fuel cell 143. The load ratio is a proportion of an output current to a rated current of the fuel cell. As shown in FIG. 4, a load ratio at which efficiency is maximum is determined for each fuel cell 143, and the efficiency decreases as the load ratio becomes higher than a maximum efficiency point or becomes lower than the maximum efficiency point. The control device 16 according to the first embodiment controls the power system 14 such that an overall efficiency of the M fuel cells 143 included in the power system 14 increases.

The status identifying unit 161 identifies a usage status of each of the M fuel cells 143. Specifically, the status identifying unit 161 identifies a usage status by acquiring a current value from an ammeter provided at each of output ends of the fuel cells 143 and acquiring an average for a certain period of time (for example, 1 hour). It is shown that as the average of the current values increases, recent usage loads of the fuel cells 143 increase. The status identifying unit 161 according to other embodiments may identify a usage load based on a physical amount other than a current value. For example, the status identifying unit 161 according to other embodiments may identify a usage load based on output electric power of the fuel cells 143 or may identify a usage load based on an outlet temperature of cooling water of the fuel cells 143. Since the fuel cells 143 generate heat through a reaction, as the outlet temperature increases, recent usage loads of the fuel cells 143 increase.

In addition, the status identifying unit 161 detects electric power supplied to the bus B.

The operation amount acquisition unit 162 acquires an operation signal indicating operation amounts of the dump body 11 and the traveling device 13 from an operation device (not shown) of the transport vehicle 10.

The electric power determination unit 163 determines desired power to be output from the M fuel cells 143 for operations of the dump body 11 and the traveling device 13 based on the operation amounts acquired by the operation amount acquisition unit 162. For example, an electric power determination function indicating a relationship between the operation amounts and desired electric power is acquired in advance for each of the dump body 11 and the traveling device 13, and the electric power determination unit 163 may determine desired electric power by substituting the acquired operation amounts in the electric power determination function. The desired electric power may not necessarily be the total electric power needed for operating the dump body 11 and the traveling device 13. For example, the power system 14 calculates, as the desired electric power, a portion obtained by subtracting an output amount of the battery 144 from total electric power needed for operating the dump body 11 and the traveling device 13 when causing the fuel cells 143 to output constant electric power so that fluctuations in the operation amounts are mainly absorbed by the battery 144, a case of causing the battery 144 to output constant electric power such that fluctuations in the operation amounts are mainly absorbed by the fuel cells 143, or the like.

The load ratio determination unit 164 determines, among a first operating pattern and a second operating pattern, a pattern in which an energy loss is the minimum, that is, a pattern in which the overall efficiency of the fuel cells 143 is highest, based on the desired electric power determined by the electric power determination unit 163.

The first operating pattern is a pattern in which M fuel cells are operated under the following conditions.
N fuel cells 143 are operated at a load ratio related to the maximum efficiency point. However, N is a natural number that satisfies N≤M−1.
Electric power that is a difference between the desired electric power and the output electric power of the N fuel cells 143 is output by one fuel cell 143.
The remaining (M−N−1) fuel cells are not operated.

In the second operating patten, the M fuel cells are operated under the following conditions.
Electric power obtained by dividing the desired electric power by N is output by the N fuel cells 143. However, N is a natural number that satisfies N≤M.
The remaining (M−N) fuel cells are not operated.

The sharing determination unit 165 determines the sharing of the load ratio of each fuel cell 143 based on a usage status of each fuel cell 143 identified by the status identifying unit 161. Specifically, the sharing determination unit 165 determines sharing such that the fuel cell 143 having a low recent usage load is preferentially operated without operating the fuel cell 143 having a high recent usage load.

The operation instruction unit 166 outputs an operation instruction to the DCDC converter 145 connected to the fuel cell 143 in accordance with sharing determined by the sharing determination unit 165 and an operating pattern determined by the load ratio determination unit 164. In addition, the operation instruction unit 166 outputs, to the DCDC converter 145 connected to the battery 144, an operation instruction for outputting electric power that is a difference between electric power of the bus identified by the status identifying unit 161 and the desired electric power determined by the electric power determination unit 163. That is, the operation instruction unit 166 is an example of a battery control unit.

### Operation of Control Device 16

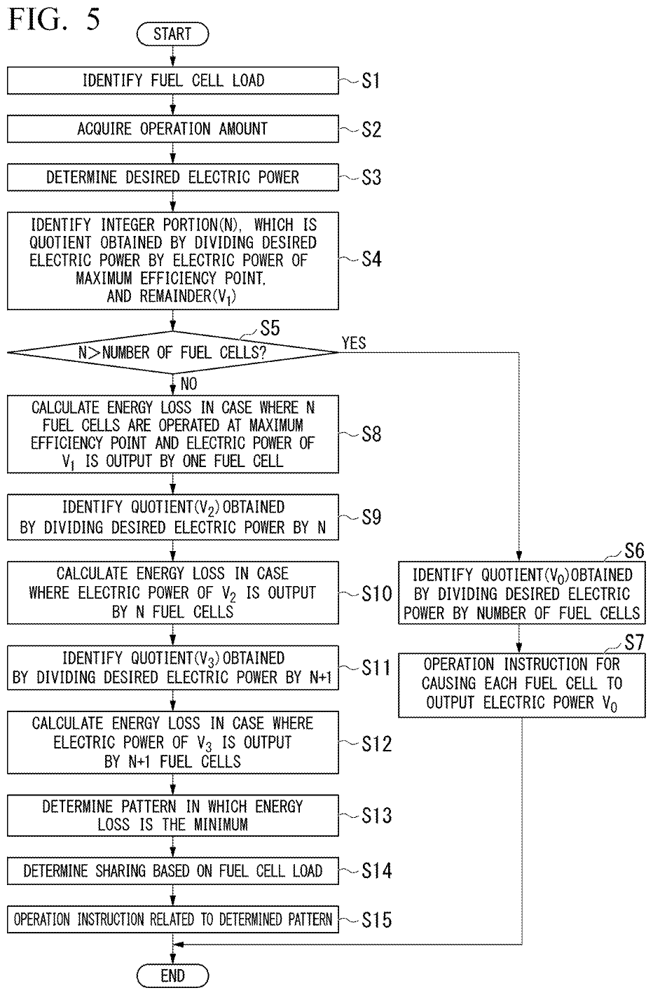

FIG. 5 is a flowchart showing an operation of the control device 16 according to the first embodiment. The control device 16 according to the first embodiment executes control processing of the fuel cells 143 shown in FIG. 5 for each predetermined fuel cell control cycle (for example, several tens of msec).

First, the status identifying unit 161 of the control device 16 identifies a usage status (usage load) of each fuel cell 143 by acquiring a state amount from a sensor provided at each fuel cell 143 (Step S1). Next, the operation amount acquisition unit 162 acquires an operation signal indicating operation amounts of the dump body 11 and the traveling device 13 from the operation device (not shown) (Step S2). The electric power determination unit 163 determines the desired electric power for operating the dump body 11 and the traveling device 13 based on the operation amounts acquired by the operation amount acquisition unit 162 (Step S3).

Next, the load ratio determination unit 164 identifies an integer portion N, which is a quotient obtained by dividing the desired electric power determined in Step S3 by electric power related to the maximum efficiency point of each fuel cell 143, and a remainder V₁ (Step S4). Since the rated output of the fuel cell 143 is known, the load ratio determination unit 164 can acquire the electric power related to the maximum efficiency point by multiplying the rated output by the load ratio related to the maximum efficiency point.

The load ratio determination unit 164 determines whether or not the integer portion N that is the quotient is larger than the number M of fuel cells 143 (Step S5). In a case where the integer portion N that is the quotient is larger than the number M of fuel cells 143 (Step S5: YES), the load ratio determination unit 164 identifies, as output electric power, a quotient V₀ obtained by dividing the desired electric power determined in Step S3 by the number M of fuel cells 143 (Step S6). Then, the operation instruction unit 166 outputs an operation instruction for outputting the output electric power V₀ identified in Step S6 to the DCDC converter 145 connected to each fuel cell 143 (Step S7). That is, the load ratio determination unit 164 determines the operating pattern of the fuel cell 143 to be the second operating pattern in which N=M.

On the other hand, in a case where the integer portion N that is the quotient is equal to or smaller than the number M of fuel cells 143 (Step S5: NO), the load ratio determination unit 164 calculates an energy loss in a case where the N fuel cells 143 are operated at the maximum efficiency point and electric power of V₁ is output by one fuel cell based on the integer portion N that is the quotient and the remainder V₁ acquired in Step S4 (Step S8). That is, the load ratio determination unit 164 calculates an energy loss for the first operating pattern.

Next, the load ratio determination unit 164 identifies a quotient V₂ obtained by dividing the desired electric power determined in Step S3 by N acquired in Step S4 (Step S9). The load ratio determination unit 164 also calculates a value after the decimal point for the quotient V₂. The load ratio determination unit 164 calculates an energy loss in a case of outputting electric power of V₂ by the N fuel cells 143 based on N acquired in Step S4 and V₂ acquired in Step S9 (Step S10). That is, the load ratio determination unit 164 calculates an energy loss for the second operating pattern in which the fuel cells 143 are operated at a load ratio exceeding the maximum efficiency point.

Next, the load ratio determination unit 164 identifies a quotient V₃ obtained by dividing the desired electric power determined in Step S3 by (N+1) based on N acquired in Step S4 (Step S11). The load ratio determination unit 164 also calculates a value after the decimal point for the quotient V₃. The load ratio determination unit 164 calculates an energy loss in a case of outputting electric power of V₃ by the (N+1) fuel cells 143 based on N acquired in Step S4 and V₃ acquired in Step S11 (Step S12). That is, the load ratio determination unit 164 calculates an energy loss for the second operating pattern in which the fuel cells 143 are operated at a load ratio lower than the maximum efficiency point.

The load ratio determination unit 164 determines an operating pattern in which an energy loss is lowest among the operating patterns calculated in Step S8, Step S10, and Step S12 to be operating patterns of the fuel cells 143 (Step S13). The sharing determination unit 165 determines the load ratio of each fuel cell 143 such that as the fuel cell 143 has a smaller load, a higher load ratio is shared, based on the load of the fuel cell 143 identified in Step S1 (Step S14). Specifically, in a case where the load ratio determination unit 164 determines the first operating pattern of Step S8, the sharing determination unit 165 determines that bottom N fuel cells having a lower usage load are operated at the maximum efficiency point, top (M−N−1) fuel cells having a higher usage load are not operated, and the electric power V₁ is output by the remaining one. In a case where the load ratio determination unit 164 determines the second operating pattern of Step S10, the sharing determination unit 165 determines that the electric power V₂ is output by bottom N fuel cells having a lower usage load and the remaining fuel cells are not operated. In a case where the load ratio determination unit 164 determines the second operating pattern of Step S12, the sharing determination unit 165 determines that the electric power V₃ is output by bottom N+1 fuel cells having a lower usage load and the remaining fuel cells are not operated.

In a case where the operating pattern determined by the load ratio determination unit 164 and the number N of operated fuel cells 143 are the same as in the previous determination, the sharing determination unit 165 does not change sharing of each fuel cell 143 and changes only the load ratio. Accordingly, frequent sharing changes can be prevented from being caused.

The operation instruction unit 166 outputs an operation instruction to the DCDC converter 145 connected to the fuel cell 143 in accordance with sharing determined by the sharing determination unit 165 and an operating pattern determined by the load ratio determination unit 164 (Step S15).

The control device 16 outputs an operation instruction for outputting electric power that is a difference between electric power of the bus B and the desired electric power to the DCDC converter 145 connected to the battery 144 in the same cycle as the fuel cell control cycle, in parallel with control processing of the fuel cells 143. The output of the fuel cells 143 does not change instantaneously and require a time of approximately several seconds for transition. As described above, as the battery 144 absorbs the difference between electric power of the bus B and the desired electric power, electric power supplied to the bus B can be stabilized.

As described above, the control device 16 according to the first embodiment determines a load ratio of each of the plurality of fuel cells 143 such that the total energy loss of the plurality of fuel cells 143 is a minimum, based on the desired electric power of the transport vehicle 10. Accordingly, the control device 16 can operate all the plurality of fuel cells 143 with high efficiency while causing the plurality of fuel cells 143 to output the desired electric power.

In addition, the control device 16 according to the first embodiment controls the plurality of fuel cells 143 based on an operating pattern in which an energy loss is the minimum among the first operating pattern and the second operating pattern. Accordingly, the control device 16 can determine an operating pattern of the fuel cell 143 with a small calculation amount without solving a complicated optimization problem in which a load ratio of each of the plurality of fuel cells 143 is used as a variable. In other embodiments, the control device 16 may calculate other operating patterns in addition to the first operating pattern and the second operating pattern or instead of one of the first operating pattern and the second operating pattern.

In addition, in a case of not operating some fuel cells 143 of the plurality of fuel cells 143, the control device 16 according to the first embodiment determines fuel cells having a larger usage load among the plurality of fuel cells 143 as fuel cells that are not to be operated. Accordingly, a load can be distributed by the plurality of fuel cells 143.

In addition, the transport vehicle 10 according to the first embodiment includes the battery 144, and the control device 16 causes the battery 144 to output electric power that is a difference between electric power output by the plurality of fuel cells 143 and the desired electric power. Accordingly, fluctuations in the load of the bus B caused by switching of the outputs of the fuel cells 143 can be absorbed by the battery 144.

### Second Embodiment

The control device 16 according to the first embodiment acquires energy losses for a plurality of operating patterns in which the desired electric power can be supplied and identifies an operating pattern in which an energy loss is the minimum. On the contrary, in a second embodiment, an operating pattern in which an energy loss is the minimum is acquired in advance through optimization calculation or the like, a pattern table for determining an operating pattern from the desired electric power is stored in the control device 16, and the control device 16 identifies an operating pattern based on the pattern table.

### Configuration of Control Device 16

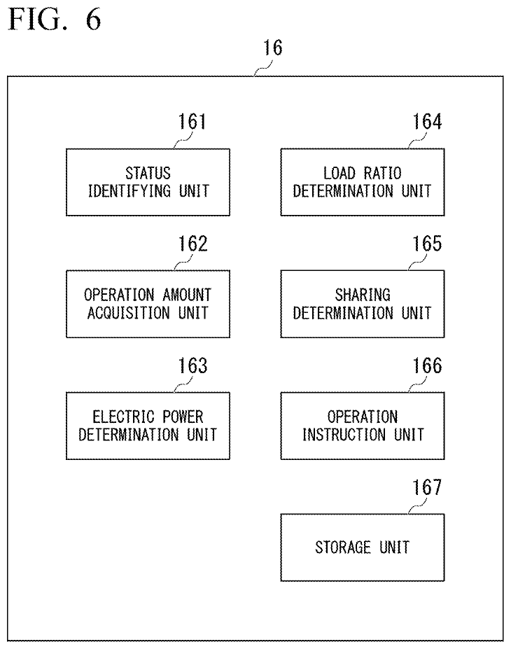

FIG. 6 is a schematic block diagram showing a configuration of the control device 16 according to the second embodiment. The control device 16 according to the second embodiment further includes a storage unit 167 in addition to the configuration of the first embodiment. The storage unit 167 stores, for each electric power range, a pattern table associated with an operating pattern in which an energy loss is the minimum when outputting electric power within the electric power range. The operating pattern may be any one of the first operating pattern and the second operating pattern as in the first embodiment or may include a different pattern. In addition, the number N of fuel cells 143 to be operated is also recorded in the pattern table. Accordingly, the load ratio determination unit 164 can identify an operating pattern in which an energy loss is the minimum by reading an operating pattern associated with the electric power range including the desired electric power determined by the electric power determination unit 163 in the pattern table.

### Operation of Control Device 16

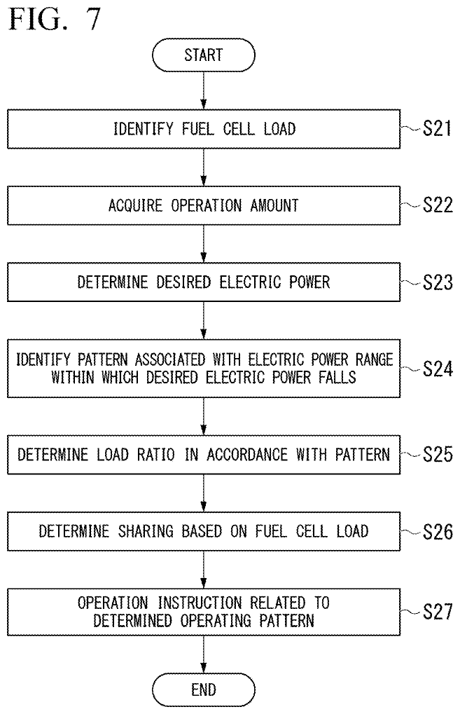

FIG. 7 is a flowchart showing an operation of the control device 16 according to the second embodiment. The control device 16 according to the second embodiment executes control processing of the fuel cells 143 shown in FIG. 7 for each predetermined fuel cell control cycle (for example, several tens of msec).

First, the status identifying unit 161 of the control device 16 identifies a usage status of each fuel cell 143 by acquiring a state amount from the sensor provided at each fuel cell 143 (Step S21). Next, the operation amount acquisition unit 162 acquires an operation signal indicating operation amounts of the dump body 11 and the traveling device 13 from the operation device (not shown) (Step S22). The electric power determination unit 163 determines the desired electric power for operating the dump body 11 and the traveling device 13 based on the operation amounts acquired by the operation amount acquisition unit 162 (Step S23).

Next, the load ratio determination unit 164 identifies an operating pattern associated with an electric power range including the desired electric power determined in Step S23 from a pattern table stored by the storage unit 167 (Step S24). The load ratio determination unit 164 determines the fuel cells 143 to be operated and the load ratio of each fuel cell 143 in accordance with the identified operating pattern (Step S25).

The sharing determination unit 165 determines a load ratio of each fuel cell 143 such that the fuel cells 143 having a smaller load share a higher load ratio, based on the loads of the fuel cells 143 identified in Step S21 (Step S26). The operation instruction unit 166 outputs an operation instruction to the DCDC converter 145 connected to the fuel cell 143 in accordance with sharing determined by the sharing determination unit 165 and an operating pattern determined by the load ratio determination unit 164 (Step S27).

The control device 16 outputs an operation instruction for outputting electric power that is a difference between electric power of the bus B and the desired electric power to the DCDC converter 145 connected to the battery 144 in the same cycle as the fuel cell control cycle, in parallel with control processing of the fuel cells 143. Outputs of the fuel cells 143 do not change instantaneously and require a time of approximately several seconds for transition. As described above, as the battery 144 absorbs the difference between electric power of the bus B and the desired electric power, electric power supplied to the bus B can be stabilized.

As described above, the control device 16 according to the second embodiment controls the plurality of fuel cells 143 based on an operating pattern in which an energy loss is the minimum among the first operating pattern and the second operating pattern. Accordingly, the control device 16 can determine an operating pattern of the fuel cell 143 with a small calculation amount without solving a complicated optimization problem in which a load ratio of each of the plurality of fuel cells 143 is used as a variable. In other embodiments, the control device 16 may calculate other operating patterns in addition to the first operating pattern and the second operating pattern or instead of one of the first operating pattern and the second operating pattern.

In addition, the control device 16 according to the second embodiment determines a load ratio of each of the plurality of fuel cells 143 based on a pattern associated with an electric power range including the desired electric power in a pattern table. The pattern table is a pattern table in which a pattern of the load ratio of each of the plurality of fuel cells 143, in which an energy loss is the minimum when outputting electric power within an electric power range, is associated with each electric power range and is an example of pattern data. Accordingly, the control device 16 can appropriately determine the load ratio of the fuel cell 143 with a small calculation amount.

### Other Embodiments

Although one embodiment has been described in detail with reference to the drawings hereinbefore, the configuration is not limited to the description above, and various design changes are possible. That is, in other embodiments, order of processing described above may be changed as appropriate. In addition, part of the processing may be executed in parallel.

The control device 16 according to the embodiments described above may be configured by a single computer, or the configuration of the control device 16 may be divided and disposed into a plurality of computers, and the plurality of computers may function as the control device 16 by cooperating with each other. In this case, some computers configuring the control device 16 may be mounted inside the transport vehicle 10, and the other computers may be provided outside the transport vehicle 10.

Although the dump truck that is the transport vehicle 10 has been described as an example of the work machine in the embodiments described above, the invention is not limited thereto. For example, a work machine according to other embodiments may be other work machines such as a hydraulic excavator and a wheel loader.

Although the control device 16 selects an operating pattern in which an energy loss of the fuel cell 143 is the minimum from the operating patterns determined in advance in the embodiments described above, the invention is not limited thereto. For example, the control device 16 according to other embodiments may calculate an operating pattern in which an energy loss is the minimum online through optimization calculation or the like.

### Computer Configuration

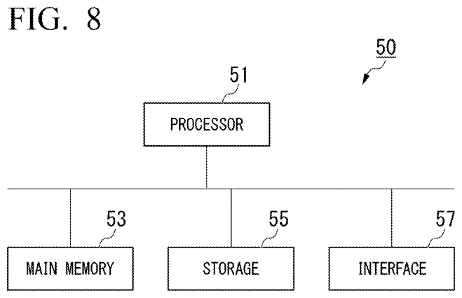

FIG. 8 is a schematic block diagram showing a configuration of a computer according to at least one embodiment.

A computer 50 includes a processor 51, a main memory 53, a storage 55, and an interface 57.

The control device 16 described above is mounted on the computer 50. The operation of each processing unit described above is stored in the storage 55 in the form of a program. The processor 51 reads the program from the storage 55, develops the program in the main memory 53, and executes the processing in accordance with the program. In addition, the processor 51 secures a storage area corresponding to each of the storage units described above in the main memory 53 in accordance with the program. A central processing unit (CPU), a graphic processing unit (GPU), and a microprocessor are exemplary examples of the processor 51.

The program may be for realizing of some of the functions of the computer 50. For example, the program may perform functions in combination with another program already stored in the storage or in combination with another program implemented in another device. In other embodiments, the computer 50 may include a custom large scale Integrated circuit (LSI) such as a programmable logic device (PLD) in addition to or instead of the above configuration. A programmable array logic (PAL), a generic array logic (GAL), a complex programmable logic device (CPLD), and a field programmable gate array (FPGA) are exemplary examples of the PLD. In this case, some or all of the functions to be realized by the processor 51 may be realized by the integrated circuit. Such an integrated circuit is also included as an example of the processor.

A magnetic disk, a magneto-optical disk, an optical disk, and a semiconductor memory are exemplary examples of the storage 55. The storage 55 may be an internal medium directly connected to a bus of the computer 50 or may be an external medium connected to the computer 50 via the interface 57 or a communication line. In addition, in a case where the program is transmitted to the computer 50 via the communication line, the computer 50 receiving the transmission may develop the program on the main memory 53 and execute the processing. In at least one embodiment, the storage 55 is a non-transitory tangible storage medium.

In addition, the program may be for realizing some of the functions described above. Further, the program may be a so-called differential file (differential program) that realizes the functions described above in combination with other programs already stored in the storage 55.

### INDUSTRIAL APPLICABILITY

According to the aspect, the plurality of fuel cells mounted on the work machine can be efficiently operated.

### REFERENCE SIGNS LIST

10: Transport vehicle
11: Dump body
12: Vehicle body
13: Traveling device
14: Power system
141: Hydrogen tank
142: Hydrogen supply device
143: Fuel cell
144: Battery
145: DCDC converter
15: Drive system
151: Inverter
152: Pump drive motor
153: Hydraulic pump
154: Hoist cylinder
155: Inverter
156: Travelling drive motor
16: Control device
161: Status identifying unit
162: Operation amount acquisition unit
163: Electric power determination unit
164: Load ratio determination unit
165: Sharing determination unit
166: Operation instruction unit
167: Storage unit

1. A control device of a work machine including a plurality of fuel cells, the control device comprising:
a load ratio determination unit configured to determine a load ratio of each of the plurality of fuel cells based on desired electric power of the work machine; and
an operation instruction unit configured to operate each of the plurality of fuel cells at the determined load ratio.

2. The control device of a work machine according to claim 1,
wherein the load ratio determination unit determines the load ratio of each of the plurality of fuel cells such that a total energy loss of the plurality of fuel cells is the minimum, based on the desired electric power of the work machine.

3. The control device of a work machine according to claim 1,
wherein the load ratio determination unit determines the load ratio of each of the plurality of fuel cells such that at least one fuel cell of the plurality of fuel cells is not operated.

4. The control device of a work machine according to claim 1,
wherein the desired electric power is determined based on at least an operation amount of a dump body.

5. The control device of a work machine according to claim 1,
wherein the load ratio determination unit calculates the load ratio for a plurality of patterns including a pattern in which N fuel cells of the plurality of fuel cells are operated at a load ratio related to a maximum efficiency point, one fuel cell is caused to output electric power that is a difference between the desired electric power and output electric power of the N fuel cells, and the remaining fuel cells are not operated and a pattern in which each of the N fuel cells of the plurality of fuel cells is caused to output electric power obtained by dividing the desired electric power by N and the remaining fuel cells are not operated, and determines the load ratio of each of the plurality of fuel cells based on a pattern in which a total energy loss of the plurality of fuel cells is the minimum.

6. The control device of a work machine according to claim 1, further comprising:
a storage unit configured to store pattern data in which a pattern of the load ratio of each of the plurality of fuel cells, in which an energy loss is the minimum when outputting electric power within an electric power range, is associated with each electric power range,
wherein the load ratio determination unit determines the load ratio of each of the plurality of fuel cells based on the pattern associated with the electric power range including the desired electric power in the pattern data.

7. The control device of a work machine according to claim 1, further comprising:
a status identifying unit configured to identify usage statuses of the plurality of fuel cells,
wherein in a case of not operating some fuel cells of the plurality of fuel cells, the load ratio determination unit determines fuel cells that are not to be operated, among the plurality of fuel cells, based on the usage statuses.

8. The control device of a work machine according to claim 1,
wherein the work machine further includes a battery, and
the control device further comprises a battery control unit configured to cause the battery to output electric power that is a difference between electric power output by the plurality of fuel cells and the desired electric power.

9. A control method of a work machine including a plurality of fuel cells, the control method comprising:
a step of determining a load ratio of each of the plurality of fuel cells based on desired electric power of the work machine; and
a step of operating each of the plurality of fuel cells at the determined load ratio.

10. The control device of a work machine according to claim 2,
wherein the load ratio determination unit determines the load ratio of each of the plurality of fuel cells such that at least one fuel cell of the plurality of fuel cells is not operated.

11. The control device of a work machine according to claim 2,
wherein the desired electric power is determined based on at least an operation amount of a dump body.

12. The control device of a work machine according to claim 3,
wherein the desired electric power is determined based on at least an operation amount of a dump body.

13. The control device of a work machine according to claim 2,
wherein the load ratio determination unit calculates the load ratio for a plurality of patterns including a pattern in which N fuel cells of the plurality of fuel cells are operated at a load ratio related to a maximum efficiency point, one fuel cell is caused to output electric power that is a difference between the desired electric power and output electric power of the N fuel cells, and the remaining fuel cells are not operated and a pattern in which each of the N fuel cells of the plurality of fuel cells is caused to output electric power obtained by dividing the desired electric power by N and the remaining fuel cells are not operated, and determines the load ratio of each of the plurality of fuel cells based on a pattern in which a total energy loss of the plurality of fuel cells is the minimum.

14. The control device of a work machine according to claim 3,
wherein the load ratio determination unit calculates the load ratio for a plurality of patterns including a pattern in which N fuel cells of the plurality of fuel cells are operated at a load ratio related to a maximum efficiency point, one fuel cell is caused to output electric power that is a difference between the desired electric power and output electric power of the N fuel cells, and the remaining fuel cells are not operated and a pattern in which each of the N fuel cells of the plurality of fuel cells is caused to output electric power obtained by dividing the desired electric power by N and the remaining fuel cells are not operated, and determines the load ratio of each of the plurality of fuel cells based on a pattern in which a total energy loss of the plurality of fuel cells is the minimum.

15. The control device of a work machine according to claim 2, further comprising:
a storage unit configured to store pattern data in which a pattern of the load ratio of each of the plurality of fuel cells, in which an energy loss is the minimum when outputting electric power within an electric power range, is associated with each electric power range,
wherein the load ratio determination unit determines the load ratio of each of the plurality of fuel cells based on the pattern associated with the electric power range including the desired electric power in the pattern data.

16. The control device of a work machine according to claim 3, further comprising:
a storage unit configured to store pattern data in which a pattern of the load ratio of each of the plurality of fuel cells, in which an energy loss is the minimum when outputting electric power within an electric power range, is associated with each electric power range,
wherein the load ratio determination unit determines the load ratio of each of the plurality of fuel cells based on the pattern associated with the electric power range including the desired electric power in the pattern data.

17. The control device of a work machine according to claim 2, further comprising:
a status identifying unit configured to identify usage statuses of the plurality of fuel cells,
wherein in a case of not operating some fuel cells of the plurality of fuel cells, the load ratio determination unit determines fuel cells that are not to be operated, among the plurality of fuel cells, based on the usage statuses.

18. The control device of a work machine according to claim 3, further comprising:
a status identifying unit configured to identify usage statuses of the plurality of fuel cells,
wherein in a case of not operating some fuel cells of the plurality of fuel cells, the load ratio determination unit determines fuel cells that are not to be operated, among the plurality of fuel cells, based on the usage statuses.

19. The control device of a work machine according to claim 2,
wherein the work machine further includes a battery, and
the control device further comprises a battery control unit configured to cause the battery to output electric power that is a difference between electric power output by the plurality of fuel cells and the desired electric power.

20. The control device of a work machine according to claim 3,
wherein the work machine further includes a battery, and
the control device further comprises a battery control unit configured to cause the battery to output electric power that is a difference between electric power output by the plurality of fuel cells and the desired electric power.
